(19) United States
(12) Patent Application Publication
(10) Pub. No.: US 2026/0288572 A1
(43) Pub. Date: Sep. 24, 2026

(54) DETECTION OF STRUCTURED CONTENT IN UNSTRUCTURED DATA FOR IMPROVED DATA LOSS PREVENTION

(71) Applicant: Palo Alto Networks, Inc., Santa Clara, CA (US)

(72) Inventors: Dongdong Sun, Sunnyvale, CA (US); Anirudh Mittal, San Jose, CA (US)

(21) Appl. No.: 19/084,444

(22) Filed: Mar. 19, 2025

(51) Int. Cl. G06F 11/08

(52) U.S. Cl. CPC G06F 11/08

(57) ABSTRACT

A structure-based data loss prevention system (“DLP system”) prefilters structured documents in a DLP pipeline to improve overall performance and efficiency. As data is detected as potentially sensitive for satisfying DLP rules/patterns, the DLP system converts the data into two-dimensional grids of tokens with new lines omitted and classifies the grids as structured or unstructured with a lightweight classifier. The DLP system invokes a language model to identify sensitive data unstructured data using context, while prefiltering structured data and reverting to the rules/patterns that were satisfied for detecting sensitive data.

### BACKGROUND

The disclosure generally relates to data processing and computing arrangements based on computational models (e.g., CPC subclass G06N and CPC subclass G06F 16).

Data loss prevention (DLP) refers to a system's ability to identify, monitor, and protect data in use, data in motion, and data at rest. Data loss is the loss of control of confidential or sensitive data (“data leakage”) and/or the compromise of integrity or availability of data. The different states of data (i.e., data at rest, data in-motion or in-transit, and data at the endpoint) have different vectors of data loss. The ability to monitor and protect data in motion can also be referred to as data leakage prevention. One vector of data loss is directly from users, for instance by accidentally communicating sensitive data over public or vulnerable channels of communication such as chat messages communicated via Software-as-a-Service applications.

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model, and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large language models (LLMs) are based on the Transformer architecture. An LLM is “large” because the training parameters are typically in the billions. LLMs can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model or changing the weights of the language model.

### BRIEF DESCRIPTION OF THE DRAWINGS

Embodiments of the disclosure may be better understood by referencing the accompanying drawings.

FIG. 1 is a diagram of a structure-based DLP system using a lightweight structured data detection model to prefilter text documents comprising structured data prior to invoking an unstructured data DLP model.

FIG. 2 is a diagram of an example architecture for a lightweight structured data detection model.

FIG. 3 is a flowchart of example operations for detecting sensitive data in structured and unstructured documents with structured document prefiltering.

FIG. 4 is a flowchart of example operations for training a lightweight classifier to prefilter unstructured documents for DLP.

FIG. 5 depicts an example computer system with a structure-based DLP system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

While structured data can be investigated for data leakage using rules/patterns, it may lack the context found in unstructured data that allows analysis by a language model. For instance, thorough analysis of unstructured data for DLP may involve use of a Bidirectional Encoder Representations from Transformers (BERT) model, an LLM, or another heavyweight model. Such analyses may not be possible at scale, when rules-based detections number in the thousands or millions, and moreover are not necessary for structured data when the sensitive data is being detected by the rules/patterns. As a separate but also pertinent obstacle, detecting formatted/structured data using rules or heuristics may have low accuracy and not cover the breadth of structured data types, leading to false positives and negatives. The present disclosure submits a lightweight neural network (instead of rules or heuristics) for effectively determining whether potentially sensitive data detected by DLP rules/patterns comprises structured data therein. Identifying structured data within potentially sensitive data allows for falling back on the rules/patterns that were satisfied for the structured data as accurate detections of data leakage while also forwarding unstructured data to a language model to contextual classification of sensitive data there.

As text documents are inspected for DLP and potentially sensitive documents are identified that satisfy rules/patterns, a text preprocessor receives the text documents, tokenizes the text documents while removing new line tokens, then arranges the tokens for each document in a grid. The grid has a predefined length and width that are engineered to be effective for detecting structured data. A lightweight detection model (e.g., a convolutional neural network (CNN)) receives each grid of tokens as input and outputs a verdict for whether the corresponding text document comprises structured data. For text documents classified as including structured data, the satisfied rules/patterns are then used to identify sensitive data and perform corrective action thereof. For text documents not classified as including sensitive data, these unstructured text documents are forwarded to a language model for more granular/intensive identification of sensitive data therein. The use of a lightweight structured detection model as a prefilter of structured documents reduces the computational resources for having to use a language model or other heavyweight model to inspect text documents that are actually structured and can be analyzed for DLP using efficient rules-based detection.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Example Illustrations

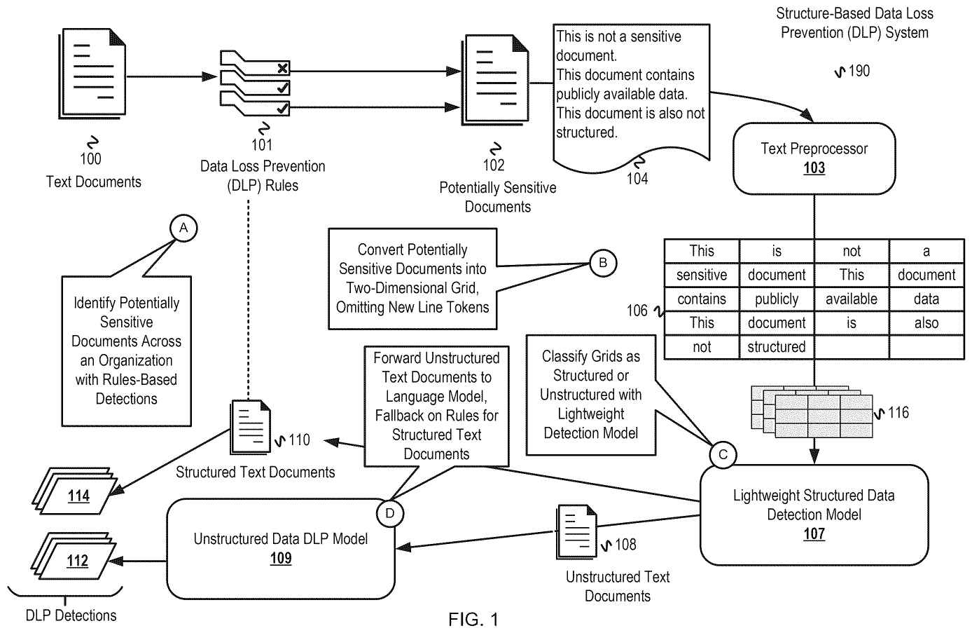

FIG. 1 is a diagram of a structure-based DLP system using a lightweight structured data detection model to prefilter text documents comprising structured data prior to invoking an unstructured data DLP model. A structure-based DLP system 190 comprises a text preprocessor 103 that converts text documents into grids of tokens, a lightweight structured data detection model (“detection model”) 107 that classifies grids of tokens as structured or unstructured, and an unstructured data DLP model (“unstructured model”) 109 that identifies data leakage (i.e., sensitive data) in text documents classified as unstructured by the detection model 107.

FIG. 1 is annotated with a series of letters A-D representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, a set of DLP rules 101 is applied to text documents 100 to identify potentially sensitive documents 102. The set of DLP rules 101 can comprise regular expressions or any other patterns that can be applied to text documents to identify data leakage. The text documents 100 comprise any text data that is detected via any of the DLP modes (i.e., data at rest, data in-motion or in-transit, and data at the endpoint) across an organization that the DLP system 190 monitors. The set of DLP rules 101 can be maintained by a domain-level expert and can be refined to the context of the organization. For instance, an organization managing sensitive customer data can have rules/patterns designed to detect the type of customer data being managed (e.g., social security numbers, driver's license numbers, credit card numbers, etc.). Moreover, the set of DLP rules 101 can be designed to detect data formatted in schema according to common structured data formats (e.g., comma-separated values documents, Microsoft® Excel documents, JavaScript® Object Notation (JSON) documents, etc.). The text documents 100 can include text detected using optical character recognition (OCR) applied to images communicated or stored in the various DLP modes across the organization.

At stage B, the text preprocessor 103 converts the potentially sensitive documents 102 into grids 116. Although structured documents may have formatting that defines tables or other structures, the breadth of such structures across data formats means that the structures are not always easily identified. The use of grid data structures allows for the detection model 107 to learn structured without having to rely on specific formatting (e.g., format defined by file types, format defined by tables of unknown width and length, etc.). Cells in each of the grids 116 comprise tokens from a corresponding one of the potentially sensitive documents 102 formatted into a grid data structure having a predefined length and width (e.g., 128 by 256. First, the text preprocessor 103 extracts tokens from each of the potentially sensitive documents 102 and removes new line tokens. For instance, the text preprocessor 103 can tokenize the potentially sensitive documents 102 as Unicode® Transformation Format-8-bit (UTF-8) strings with Python® libraries or with the Character Architecture with No tokenization In Neural Encoders (CANINE) encoder. Each token can be represented as a Unicode integer rather than a string when stored in the corresponding grid cell. Then, the text preprocessor 103 populates a grid data structure having the predefined length and width with the tokens in sequential order as they occurred in the potentially sensitive documents 102. An example document 104 that is unstructured and non-sensitive comprises the text:
This is not a sensitive document.
This document contains publicly available data.
This document is also not structured.
An example grid 106 includes each token in the example document 102 as a cell in a four-by-four grid with punctuation and new line tokens removed.

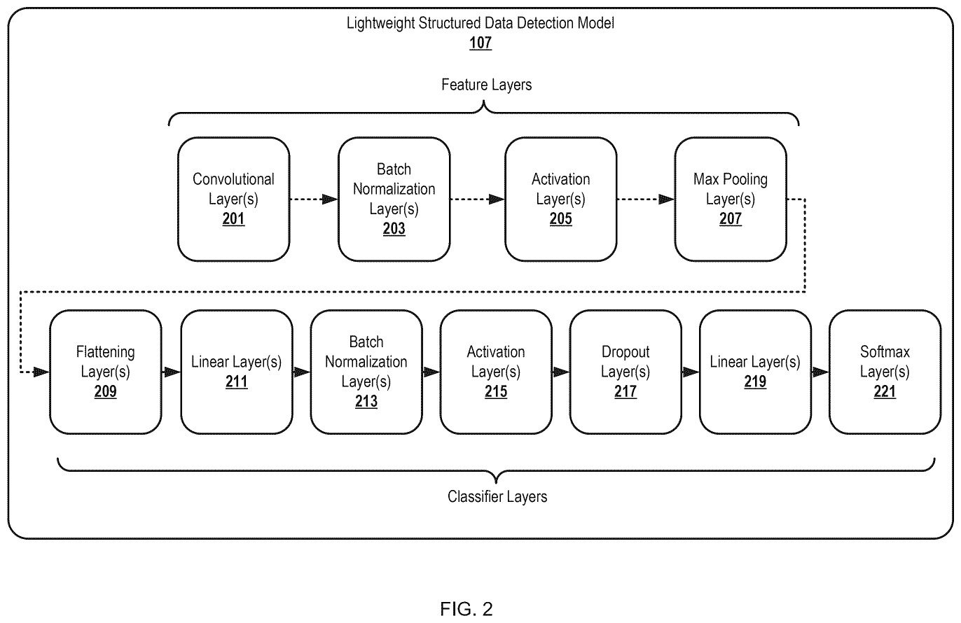

At stage C, the detection model 107 classifies each of the grids 116 as structured or unstructured. The detection model 107 is lightweight, i.e., less than 100,000 internal parameters. The detection model 107 can comprise a CNN or other lightweight neural network classifier. An example architecture for the detection model 107 is depicted in FIG. 2. The detection model 107 was trained on grids of tokens having the predefined length and width extracted from documents known to be structured or unstructured. For instance, the documents can be collected and labeled by domain-level experts for the organization. Although FIG. 1 depicts the detection model 107 as a binary classifier that classifies documents as structured or unstructured, the detection model 107 can be a multiclass classifier. For instance, the detection model 107 can be trained to classify documents as a table (structured), OCR of a table (structured), or unstructured. Those of the potentially sensitive documents 102 that have an unstructured verdict from the detection model 107 on a corresponding one of the grids 116 comprise unstructured text documents 108, and those of the potentially sensitive documents 102 that have a structured verdict from the detection model 107 on a corresponding one of the grids 116 comprise structured text documents 110.

At stage D, the detection model 107 forwards the unstructured text documents 108 to the unstructured model 109 and falls back on the DLP rules 101 for the structured text documents 110. The unstructured model 109 comprises a language model trained/configured to detect sensitive unstructured data. For instance, the unstructured model 109 can comprise a BERT model that is, configured, fine-tuned, or otherwise trained to identify sensitive data within unstructured text. The BERT model can be trained on general natural language tasks and then configured for the task of detecting sensitive data from unstructured data. As another example, the unstructured model 109 can comprise an LLM that learns to identify sensitive data within unstructured text via one-shot or few-shot prompting with prompts engineered for this task. Typically, the unstructured model 109 is a heavyweight model (e.g., more than a million internal parameters) than the detection model 107 due to the difficulty of the task of detecting sensitive data without the reliance on existing structure that can otherwise indicate where sensitive data may be included. The unstructured model 109 outputs verdicts 112 that indicate the existence and location of sensitive data in the unstructured text documents 108. Likewise, the DLP rules 101 also output verdicts 114 that indicate the existence and location of sensitive data in the structured text documents 110. A cybersecurity system (not depicted) managing DLP across the organization may perform a remediation action(s) based on the verdicts 112 and 114. Example remediation actions include obfuscating or removing sensitive data, generating alerts to users and/or administrators, blocking or more closely monitoring network traffic and/or data storage where the sensitive data was identified, etc.

FIG. 2 is a diagram of an example architecture for a lightweight structured data detection model. FIG. 2 depicts an example architecture for the detection model 107 depicted in FIG. 1. The example architecture comprises feature layers for generating features of grids of tokens and classifier layers for outputting classifications of the grids, i.e., probability vectors indicating likelihood of corresponding text documents being a table, OCR of a table, or unstructured. Each layer is separated by arrows with dotted lines to indicate that the order and number of each type of layer can vary by implementation. The feature layers include a convolution layer(s) 201, a batch normalization layer(s) 203, an activation layer(s) 205, and a max pooling layer(s) 207. The classifier layers include a flattening layer(s) 209, a linear layer(s) 211, a batch normalization layer(s) 213, an activation layer(s) 215, a dropout layer(s) 217, a linear layer(s) 219, and a softmax layer(s) 221.

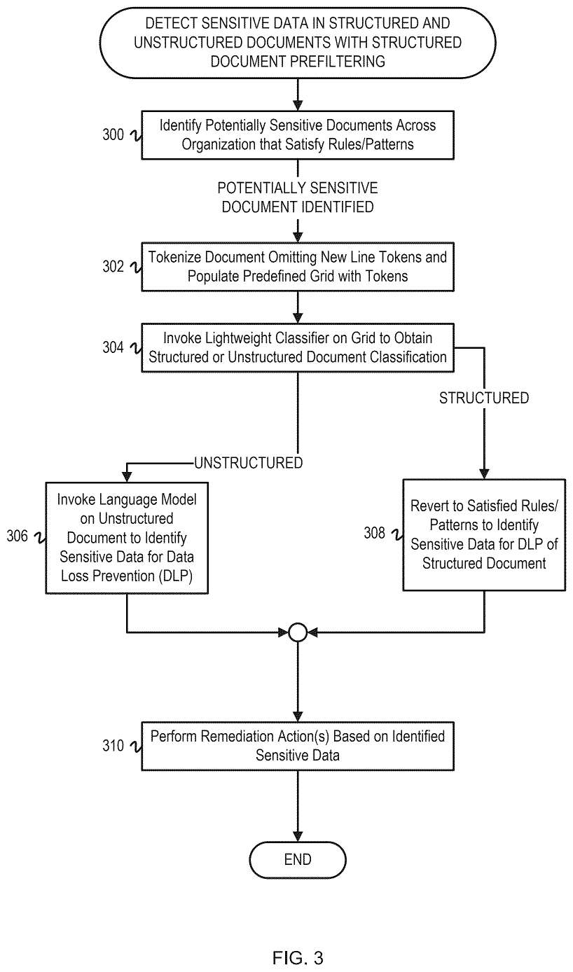

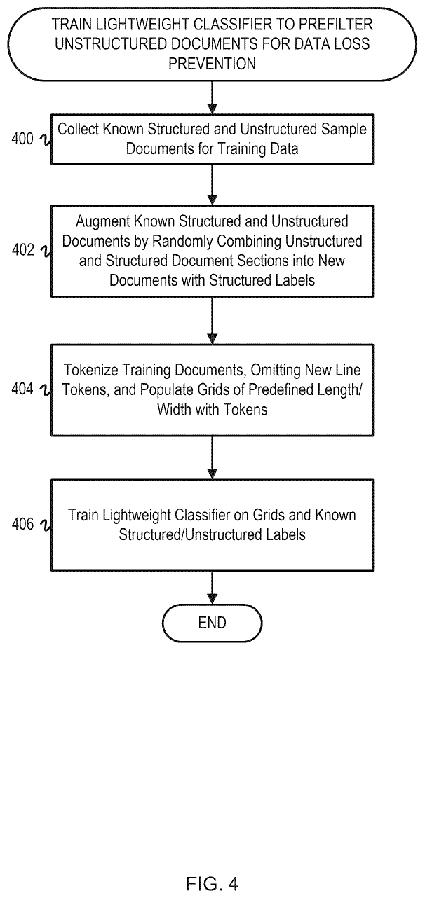

FIGS. 3 and 4 are flowcharts of example operations for training and deploying a lightweight classifier for prefiltering structured text documents for DLP. The example operations are described with reference to a structure-based DLP system (“DLP system”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting sensitive data in structured and unstructured documents with structured document prefiltering. At block 300, the DLP system identifies potentially sensitive documents across an organization that satisfy rules/patterns. The DLP system can monitor network traffic, data stores, memory and/or disk storage at endpoints, etc. for identifying the potentially sensitive documents. The rules/patterns can comprise regular expressions, keywords, etc. that are designed to detect sensitive data. Moreover, the rules/patterns can be designed specific to the organization, for instance by a domain-level expert with knowledge of the typical types of sensitive data that are leaked across the organization. As an example, when the organization stores customer data, the rules/patterns could be regular expressions for detecting credit card numbers. The operations at block 300 are ongoing until an additional potentially sensitive document is identified by the DLP system, which triggers the remaining operations in FIG. 3.

At block 302, the DLP system tokenizes the document while omitting new line tokens and populates a predefined grid with the tokens. In other words, the DLP system formats the document into a two-dimensional grid. The predefined grid has a fixed length and width that is chosen by a domain-level expert based on previously observed documents across the organization. The tokens can comprise UTF-8 strings, other Unicode format strings, American Standard Code for Information Interchange (ASCII) strings, etc. The tokenization can be performed using existing libraries, e.g., the Natural Language Toolkit (NLTK) in the Python programming language. The DLP system populates the grid with the tokens according to the sequential order that they occur in the document. To exemplify, if the document has ten tokens and the grid has four rows and three columns, the first three tokens are populated in the first row, the second three tokens are populated in the second row, the third three tokens are populated in the third row, and the last token is populated in the fourth row with two empty places in the grid at the end of the fourth row. If there are more tokens in the document that there are places in the grid (i.e., the number of documents is greater than the length of the grid multiplied by the width of the gird), the DLP system can generate multiple grids for the document by splitting up the document into sets of tokens with size less than or equal to the number of places in the grid.

At block 304, the DLP system invokes a lightweight classifier on the grid to obtain a structured or unstructured document classification. As mentioned in the foregoing, the classification can comprise a multiclass classification rather than a binary structured or unstructured classification, for instance a classification as a table, OCR of a table, or unstructured data. The lightweight classifier can comprise a neural network or other machine learning classifier that is able to handle a high volume of detections (e.g., hundreds of millions of documents per month). If the document classification is unstructured, operational flow proceeds to block 306. Otherwise, operational flow proceeds to block 308.

At block 306, the DLP system invokes a language model on the unstructured document to identify sensitive data in the document for DLP. The language model both verifies whether the unstructured document includes sensitive data and identifies a location(s) of the sensitive data in the unstructured document. For instance, the language model can comprise a BERT models and the DLP system can invoke the BERT model with the tokenization of the document. Alternatively, the language model can comprise an LLM and the DLP system can prompt the LLM with a prompt comprising the tokenization of the document and task instructions to identify sensitive data therein. The BERT model and/or LLM can be trained with synthetic personally identifiable information (PII) data generated by an LLM, and the PII data can be for types of PII specific to the organization. The prompt can further comprise an indication that the document is unstructured and task instructions to, if sensitive data is identified, determine a type(s) of sensitive data in the document. In some embodiments, the language model can be fine-tuned, prompt-tuned, trained, adapted via one- or few-shot prompting, etc. for detecting sensitive data specific to the organization, for instance by providing the language model with examples of sensitive data in unstructured documents as part of its conversation history. Operational flow proceeds to block 310.

At block 308, the DLP system reverts to the satisfied rules/patterns to identify sensitive data for DLP of the structured documents. Each of the rules/patterns correspond to a section of text (e.g., a token or phrase that satisfied a regular expression) where the sensitive data that satisfied the rules/patterns is located.

At block 310, the DLP system performs a remediation action(s) based on the identified sensitive data. The remediation action(s) can comprise removal or obfuscation of the sensitive data, generating an alert to a user or administrator indicating the sensitive data and/or type of sensitive data, increasing precautions regarding data in use, in motion, and at rest across the organization, etc. The choice of remediation action(s) can depend on the type of sensitive data, with sensitive data types having higher risk levels (e.g., socials security numbers) resulting in higher severity remediation actions than sensitive data types having lower risk levels (e.g., names).

FIG. 4 is a flowchart of example operations for training a lightweight classifier to prefilter unstructured documents for DLP. At block 400, the DLP system collects known structured and unstructured sample documents for training data. The known structured and unstructured sample documents can be collected across an organization and labeled by an expert in DLP for the organization. The documents can be labeled not just as unstructured or structured, but into multiple classes such as tables, OCR of tables, etc. In some embodiments, the known structured and unstructured sample documents can be supplemented by public DLP datasets. The classifier is “lightweight” in the sense that the classifier has a small number of internal parameters (e.g., less than or equal to one hundred thousand internal parameters) and is able to handle a high volume (e.g., millions a day) of document classifications with minimal latency (e.g., less than or equal to ten milliseconds).

At block 402, the DLP system augments the known structured and unstructured documents by randomly combing unstructured and structured document sections into new documents with structured labels (and/or the multiclass structured labels inherited from the structured documents that were randomly combined) to make hybrid files comprising both structured and unstructured data. The goal of randomly combining structured and unstructured documents to augment the training data is so that the lightweight classifier can more effectively identify structured data within otherwise unstructured documents. The DLP system can randomly subsample the known structured and unstructured documents (e.g., by randomly choosing twenty percent of each dataset), can randomly truncate each subsampled document (e.g., by choosing the truncation uniformly at random according to the document length), and can then collate truncated structured documents with truncated unstructured documents for the augmentation.

At block 404, the DLP system tokenizes the training documents while omitting new line tokens and populates grids of a predefined length/width with the tokens. If a training document has more tokens than the predefined length times the predefined width, the DLP system can split the tokens for that training document into multiple sets of tokens each smaller than the predefined length times the predefined width and can generate multiple grids for each set of tokens for the training document. Although the new line tokens are omitted, the resulting grids still have line breaks according to the grid structure between each row of tokens.

At block 406, the DLP system trains the lightweight classifier on the grids and corresponding known structured/unstructured labels. Training of the lightweight classifier depends on the choice of classifier—for instance, if the lightweight classifier is a neural network, then training occurs in iterations of batches and epochs using backpropagation until training termination criteria are satisfied (e.g., a threshold number of iterations has occurred, training/testing loss is sufficiently low, internal parameters converge across iterations, etc.).

### Variations

The foregoing refers to “documents” and “text documents” as being identified and analyzed for detection and remediation of sensitive data. More generally, sensitive data can be identified in any data in use, in motion, and/or at rest across an organization being monitored for DLP that comprises text.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

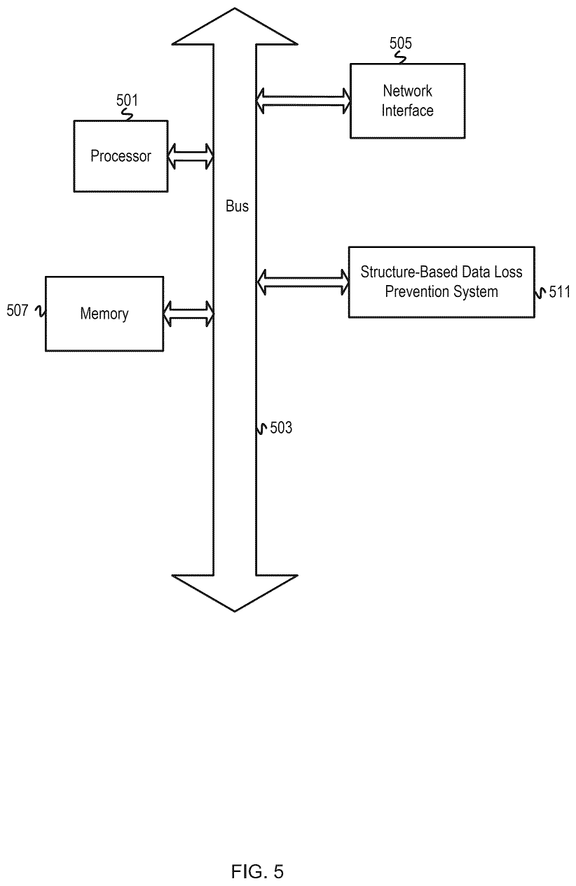

FIG. 5 depicts an example computer system with a structure-based DLP system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a structure-based DLP system (“DLP system”) 511. The DLP system 511 applies rules/patterns to data being monitored across an organization. When data is detected as being potentially sensitive, (i.e., data satisfies one or more of the rules/patterns), the DLP system invokes a lightweight classifier to classify the data as structured or unstructured. For unstructured data, the DLP system invokes a language model to identify sensitive data therein based on context included in the unstructured data. For structured data, the DLP system relies on the rule/pattern-based detections to identify sensitive data satisfying the rules/patterns. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
based on detecting potentially sensitive data satisfying one or more rules for data loss prevention, formatting the potentially sensitive data as a two-dimensional grid, wherein each cell in the two-dimensional grid corresponds to a token in the potentially sensitive data;
invoking a first machine learning model with an input comprising the two-dimensional grid to determine whether the potentially sensitive data comprises structured data; and
based on determining that the formatted potentially sensitive data does not comprise structured data, forwarding the potentially sensitive data to a second machine learning model to verify whether the potentially sensitive data is sensitive.

2. The method of claim 1, wherein the first machine learning model was trained to predict whether potentially sensitive data represented as two-dimensional grids comprise a table, optical character recognition of a table, or unstructured data.

3. The method of claim 1, wherein formatting the potentially sensitive data comprises:
tokenizing the potentially sensitive data into tokens; and
populating the two-dimensional grid with the tokens according to ordering of the tokens in the potentially sensitive data with new line tokens omitted.

4. The method of claim 1, further comprising, based on determining that the formatted potentially sensitive data does not comprise structured data, identifying sensitive data in the potentially sensitive data according to the one or more rules that were satisfied.

5. The method of claim 1, wherein training the first machine learning model was trained with structured files, unstructured files, and hybrid files comprising random sections of both structured and unstructured files.

6. The method of claim 1, wherein the first machine learning model is a lightweight convolutional neural network.

7. The method of claim 1, wherein the second machine learning model is a language model.

8. A non-transitory machine-readable medium having program code stored thereon, the program code comprising instructions to:
based on detecting potentially sensitive data satisfying one or more rules for data loss prevention, formatting the potentially sensitive data as a two-dimensional grid, wherein each cell in the two-dimensional grid corresponds to a token in the potentially sensitive data;
invoking a classifier with an input comprising the two-dimensional grid to determine whether the potentially sensitive data comprises structured data; and
based on determining that the formatted potentially sensitive data does not comprise structured data, forwarding the potentially sensitive data to a language model for data loss prevention.

9. The non-transitory machine-readable media of claim 8, wherein the classifier was trained to predict whether potentially sensitive data represented as two-dimensional grids comprise a table, optical character recognition of a table, or unstructured data.

10. The non-transitory machine-readable media of claim 8, wherein the instructions to format the potentially sensitive data comprise instructions to:
tokenize the potentially sensitive data into tokens; and
populate the two-dimensional grid with the tokens according to ordering of the tokens in the potentially sensitive data with new line tokens omitted.

11. The non-transitory machine-readable media of claim 8, where the program code further comprises instruction to, based on determining that the formatted potentially sensitive data does not comprise structured data, identify sensitive data in the potentially sensitive data according to the one or more rules that were satisfied.

12. The non-transitory machine-readable media of claim 8, wherein the classifier was trained with structured files, unstructured files, and hybrid files comprising random sections of both structured and unstructured files.

13. The non-transitory machine-readable media of claim 8, wherein the classifier is a lightweight convolutional neural network.

14. The non-transitory machine-readable media of claim 8, wherein the language model is a Bidirectional Encoder Representations from Transformers model.

15. An apparatus comprising:
a processor; and
a machine-readable medium having instructions stored thereon that are executable by the processor to cause the apparatus to,
for each document being inspected for data loss prevention across an organization,
determine whether the document satisfies one or more rules for sensitive data detection;
based on a determination that the document satisfies the one or more rules, generate a grid representing the document, wherein each cell in the grid corresponds to a token in the document;
invoke a classifier on the grid to obtain a verdict indicating whether the document is structured or unstructured; and
based on the verdict indicating that the document is unstructured, forward the document to a language model for unstructured sensitive data detection.

16. The apparatus of claim 15, wherein the classifier was trained to predict whether potentially sensitive data represented as two-dimensional grids comprise a table, optical character recognition of a table, or unstructured data.

17. The apparatus of claim 15, wherein the instructions to generate the grid representing the document comprise instructions executable by the processor to cause the apparatus to:
tokenize the document into tokens; and
populate the grid with the tokens according to ordering of the tokens in the document with new line tokens omitted.

18. The apparatus of claim 15, wherein the machine-readable medium further has stored thereon instructions executable by the processor to cause the apparatus to, based on the verdict indicating that the document is unstructured, identify sensitive data in the document according to the one or more rules that were satisfied.

19. The apparatus of claim 15, wherein the classifier was trained with structured files, unstructured files, and hybrid files comprising random sections of both structured and unstructured files.

20. The apparatus of claim 15, wherein the classifier is a lightweight convolutional neural network.
